(19) United States
(12) Patent Application Publication
(10) Pub. No.: US 2025/0256610 A1
(43) Pub. Date: Aug. 14, 2025

(54) ELECTRIC VEHICLE CHARGING SYSTEM AND METHOD FOR OPERATING THE SAME

(71) Applicant: Tomorrowland Technology Co., Ltd., Taipei City (TW)

(72) Inventors: Shih-Hao CHIAO, Taipei City (TW); Ming-Chuan HUANG, Taipei City (TW); Chien-Chih KUO, Taipei City (TW)

(21) Appl. No.: 18/438,451

(22) Filed: Feb. 10, 2024

(51) Int. Cl. B60L 53/65; B60L 53/66

(52) U.S. Cl. CPC B60L 53/65; B60L 53/665

(57) ABSTRACT

The electric vehicle charging system includes charging stations and a backend management server. Each charging station has an image capture unit to capture an image of a vehicle parking in the corresponding parking space, and a control unit to perform an image recognition process on the image to retrieve the vehicle's license plate number and a model from the image. The control unit generates a determination signal to determine whether to switch the charging station from a hibernate state to a standby state to charge the vehicle based on the license plate number and the model.

### BACKGROUND

### Technical Field

The present disclosure relates to an electric vehicle charging system and a method for operating the same. More particularly, the present disclosure relates to an electric vehicle charging system having recognition function and a method for operating the same.

### Description of Related Art

Traditional vehicles generally use non-renewable energy, such as fuel oil or the like, and emit a great amount of exhaust gas, which makes against the establishment of resource sustainability and environmentally friendly society. In contrast with the traditional vehicles, electric vehicles are driven by electric power. Electrical power belongs to renewable energy and electric drive does not emit any exhaust gas. Therefore, it is widely believed that the electric vehicles will go places. Concomitantly, the electric vehicle charging management system is becoming increasingly important. Therefore, it is highly necessary to provide a charging system of high efficiency.

### SUMMARY

One aspect of the present disclosure is to provide an electric vehicle charging system including a plurality of charging stations arranged on a plurality of parking spaces respectively, wherein each of the plurality of charging stations further includes an image capturing unit, a main control unit and a charging connector provided for a vehicle on a corresponding parking space to execute charging; and a backend management server connected with the plurality of charging stations through a communication network, wherein the image capturing unit on each of the plurality of charging stations is configured to capture an image of the vehicle on the corresponding parking space, wherein the main control unit is configured to execute an image recognition process for the image to capture a license plate number and a vehicle type from the image to generate a determination signal according to the license plate number and the vehicle type to determine if a corresponding charging station is switched from a hibernate state to a standby state to execute charging for the vehicle and to collect a charging fee according to the license plate number and the vehicle type.

In some embodiments, the charging connector further includes a warning device thereon configured to send out a warning signal when the charging connector is provided for the vehicle on the corresponding parking space to execute charging.

In some embodiments, each of the plurality of charging stations further includes an extended charging tube configured to couple with the charging connector to extend a charging range of the charging connector.

In some embodiments, the image recognition process is executed by the backend management server for the image when the main control unit cannot execute the image recognition process for the image.

In some embodiments, each of the plurality of charging stations further comprises a voice warning unit coupled with the main control unit and the main control unit further controls the voice warning unit to generate a warning message when the main control unit keeps the corresponding charging station in the hibernate state according to the determination signal.

In some embodiments, each of the plurality of charging stations further includes a state indication unit coupled with the main control unit and the main control unit switches the state indication unit to indicate whether the corresponding charging station is in the hibernate state or the standby state.

In some embodiments, the image capturing unit keeps capturing a continuous image of the vehicle and the main control unit determines if the object which is charged by the charging connector is the vehicle according to the continuous image after the corresponding charging station switches from the hibernate state to the standby state.

In some embodiments, the main control unit stops charging the charging connector when the main control unit determines that the charging connector does not charge the vehicle according to the continuous image.

In some embodiments, the charging connector is locked in a charging-connector socket when in the hibernate state and the charging connector is unlocked when in the standby state.

In some embodiments, the charging connector is unlocked when in the standby state.

In some embodiments, the charging connector is locked in a charging-connector socket in the hibernate state.

In some embodiments, the charging connector is unlocked in the standby state.

In some embodiments, the image capturing unit keeps capturing a continuous image of the vehicle and the main control unit determines if an object which is charged by the charging connector is the vehicle according to the continuous image after the corresponding charging station switches from the hibernate state to the standby state, and the main control unit stops charging the charging connector when the main control unit determines that the charging connector does not charge the vehicle according to the continuous image.

In some embodiments, the backend management server provides an application program to be downloaded to execute registration.

One aspect of the present disclosure is to provide a method for operating an electric vehicle charging system including the steps of: capturing an image of a vehicle on a parking space corresponding to a charging station by using an image capturing unit provided on the charging station; sending the image to a backend management server, wherein the charging station sends the image to the backend management server through a communication network; executing an image recognition process by using a main control unit provided inside the charging station to capture a license plate number and a vehicle type; and generating a determination signal, wherein the main control unit generates the determination signal according to the license plate number and the vehicle type to decide whether to switch the charging station from a hibernate state to a standby state to execute charging for the vehicle.

In some embodiments, collecting a fee according to the license plate number and the vehicle type.

The present disclosure recognizes the license plate number and the vehicle through arranging an image capturing device on the charging stations, configured to capture the image of the charging vehicle. In addition to automatically determining if the charging process is switched on and the fee is subsequently collected, the present disclosure further executes monitoring in the charging process and thereby avoids that the charged vehicle is not the recognized vehicle and the charging connector is maliciously moved into other vehicles to execute charging.

The illustration mentioned above will be described in detail by embodiments and the technical scheme of the present disclosure will be further elucidated as follows.

### BRIEF DESCRIPTION OF THE DRAWINGS

Drawings are herein incorporated into the specification as a part of the present specification. The drawings show the embodiments in accordance with the present disclosure and accompany with the detailed description to illustrate the technical scheme.

FIG. 1 is a schematic diagram of an electronic vehicle charging system according to one embodiment of the present disclosure.

FIG. 2 is a schematic diagram of external arrangement of a charging station according to one embodiment of the present disclosure.

FIG. 3 is a schematic diagram of a charging station and a backend management server according to one embodiment of the present disclosure.

FIG. 4 is a flow diagram of a method for charging an electric vehicle in accordance with to one embodiment of the present disclosure.

### DETAILED DESCRIPTION

Below the spirit of the present disclosure will be clearly illustrated by the drawings and the detailed description. Any variation or modification added by a person having ordinary skill in the art according to the technology taught in the present disclosure after he understood the embodiments of the present disclosure, still falls within the scope and spirit of the present disclosure.

The phrases as used herein just serve the goal of describing specific embodiments and are not intended to limit the present disclosure. Similarly, the singular articles “a”, “an”, “the”, and “this” herein include the multiple conditions as well, referring to “one” or “at least one”.

The words “connected” or “coupled” herein may refer to directly or indirectly touching between two or more elements. The words “connected” or “coupled” may also refer to operations or actions between two or more elements.

The words “comprise”, “include”, “have”, “contain”, etc., are open terms, referring to “contains but is not limit to”.

The term “and/or” as used herein includes any or all combinations of the said objects.

Unless there is additional indication, the terms as used herein usually have their ordinary meanings in the art, the content of the present disclosure and the particular content. Some terms for describing the present disclosure will be discussed below or elsewhere in the specification to provide one skilled in the art with an additional guide to the description of the present disclosure.

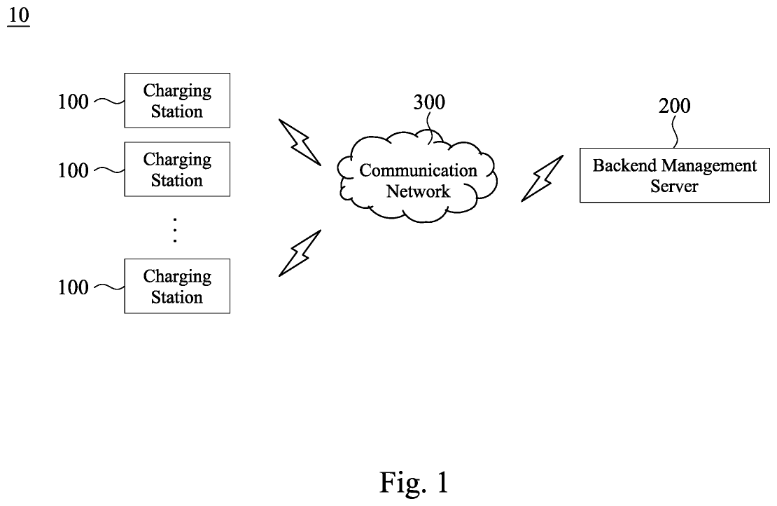

FIG. 1 is a schematic diagram of an electronic vehicle charging system according to one embodiment of the present disclosure. The electronic vehicle charging system 10 of the present disclosure includes multiple charging stations 100 and a backend management server 200. The multiple charging stations 100 are connected with the backend management server 200 through a communication network 300. In one embodiment, the communication network 300 can be implemented through any means of communication, such as internet, local area network, wide area network, Cellular Network (or mobile network), Near-field communication, infrared communication, Bluetooth, wireless fidelity (WiFi), or wired transmission. In one embodiment, each of the multiple charging stations 100 can capture an image of a vehicle on a corresponding parking space and upload the captured image to the backend management server 200 to execute storing. In one embodiment, both the charging station 100 and the backend management server 200 of the present disclosure can execute an image recognition process to recognize a license plate number and a vehicle type in the image captured by the charging station 100 to determine if the charging station 100 is switched on to execute charging for the vehicle on the corresponding parking space according to the recognition results, and to collect a fee according to the license plate number and the vehicle type after charging is complete. In one embodiment, the backend management server 200 executes the image recognition process as a backup of the charging station 100. Alternatively stated, the recognition is first executed by a main control unit (as described latter) after the charging station 100 captures the image and the backend management server 200 switches on the image recognition process to execute imagine recognition and returns recognition results to the charging station 100 to execute subsequent operations only when the main control unit does not recognize the captured image or cannot execute recognition. In one embodiment, the backend management server 200 can provide an application program to be downloaded to execute registration and logging in by using a handed device. After a registrant logs in the application program and executes a corresponding charging operation, the backend management server 200 can further provide the user with in-time charging information.

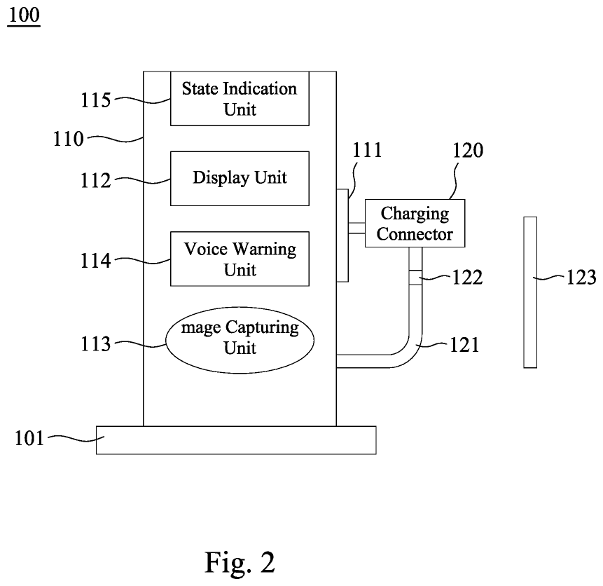

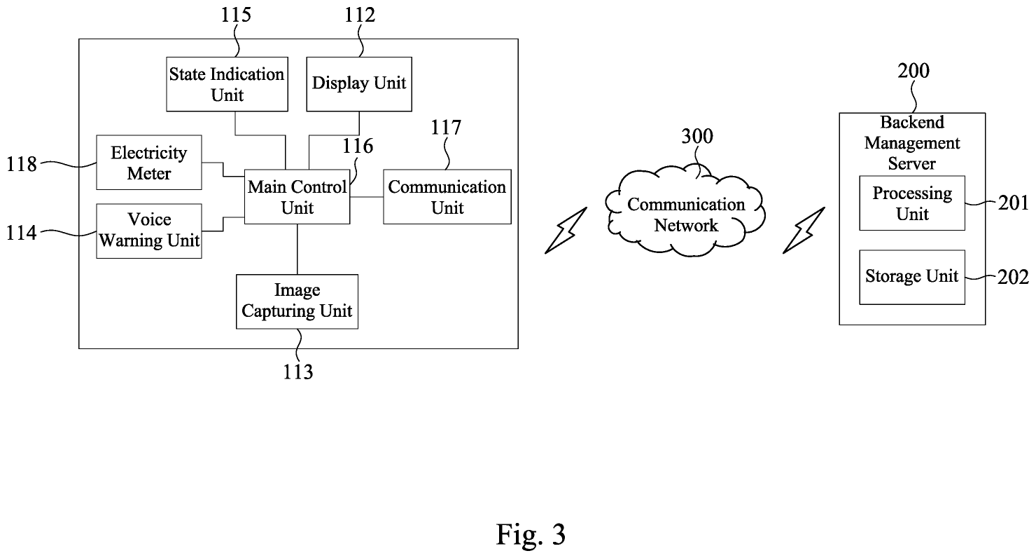

FIG. 2 is a schematic diagram of external arrangement of a charging station according to one embodiment of the present disclosure. FIG. 3 is a schematic diagram of a charging station and a backend management server according to one embodiment of the present disclosure. Reference is now made to FIG. 2 and FIG. 3. In one embodiment, the charging station 100 includes a station body 110 arranged on a base 101 and a charging connector 120. More particularly, a charging cable 121 is connected between the charging connector 120 and the station body 110. A charging-connector socket 111 is arranged on the station body 110 so that the charging connector 120 can be inserted into and locked in the charging-connector socket 111 when the charging connector 120 does not execute charging for an electric vehicle. In one embodiment, the base 101 can be a surface of a parking space on a roadside, or a surface of a parking lot. Alternatively stated, the charging station 100 of the present disclosure can be arranged on a position of the corresponding parking space for the electric vehicle on the road side or in the parking lot for charging the electric vehicle parked on the corresponding parking space. In one embodiment, the backend management server 200 has a processing unit 201 and a storage unit 202.

In one embodiment, a display unit 112, an image capturing unit 113, a voice warning unit 114, and a state indication unit 115, are provided on an outer surface of the station body 110. In one embodiment, the voice warning unit 114 can be a speaker and the state-indication unit can be a light-emitting element, such as a light-emitting diode. More particularly, all of the display unit 112, the image capturing unit 113, the voice warning unit 114, and the state indication unit 115, are coupled with the main control unit 116 provided inside the station body 110. The main control unit 116 is configured to control the operation of the charging station 100 and to execute the image recognition. In addition, a communication unit 117 and an electricity meter 118 are further provide inside the station body 110. The station body 110 can be coupled with the communication network 300 through the communication unit 117 to communicate with the backend management server 200. The electricity meter 118 is configured to measure in-time power of the charging connector 120 during the charging process of the charging connector 120.

In one embodiment, the image capturing unit 113 is configured to capture an exterior image of the vehicle on the parking space corresponding to the charging station 100. The main control unit 116 captures the exterior image of the vehicle, which is captured by the image capturing unit 113, and sends the captured image to the backend management server 200 on a remote end through the communication unit 117 to execute storing. In one embodiment, for the sake of controlling the image capturing unit 113 to capture the exterior image of the vehicle at a right timing, a proximity sensor can further be arranged on the image capturing unit 113. The image capturing unit 113 is triggered to capture the image when the vehicle on the corresponding parking space approaches the image capturing unit 113 by a specific distance.

In one embodiment, the main control unit 116 executes an image recognition process to carry on image processing, character splitting, character recognition for the exterior image of the vehicle to recognize vehicle information about the vehicle, such as the license plate number and the vehicle type, and sends the recognition results and the exterior image of the vehicle to the backend management server 200 through the communication network 300 to store them in the storage unit 202. In one embodiment, the main control unit 116 can be implemented by a central processing unit (CPU), a micro-processor unit (MPU), a micro-controller unit (MCU), a digital signal processor (DSP), and an application specific integrated circuit (ASIC).

In one embodiment, the main controller unit 116 further determine if the vehicle on the corresponding parking space is an electric vehicle according to the license plate number and the vehicle type after the main controller unit 116 recognizes the license plate number and the vehicle type of the vehicle to determine if a corresponding charging station is switched from a hibernate state to a standby state according thereto. In one embodiment, the main control unit 116 controls the voice warning unit 114 to generate a warning message to remind a vehicle owner and meanwhile keep the charging station 100 in the hibernate state, and the state indication unit 115 indicates that the charging station is in the hibernate state, if the main control unit 116 determines that the vehicle on the corresponding parking space is not an electric vehicle, i.e., the parking space for electric vehicles is illegally occupied. In other embodiments, the main control unit 116 controls the display unit 112 concurrently displays a parking regulation and the warning message to the vehicle owner for reference. In another embodiment, the main control unit 116 further determines if the vehicle on the corresponding parking space is an electric vehicle of a registered member according to the license plate number and the vehicle type if the parking space is only provided for register members. The main control unit 116 controls the voice warning unit 114 to generate a warning message to remind the vehicle owner and meanwhile keeps the charging station 100 in the hibernate state, and the state indication unit 115 indicates that the charging station 100 is in the hibernate state if the vehicle is not an electric vehicle own by a member. In one embodiment, the charging connector 120 is locked in the charging-connector socket 111. For example, the charging connector 120 is locked in the charging-connector socket 111 by a prior-art lock mechanism to avoid that the charging connector 120 is improperly pulled out to cause danger.

In another embodiment, the main control unit 116 lifts the hibernate state of the charging station 100 and switches the charging station 100 to the standby state and controls the state indication unit 115 to show that the charging station 100 is a chargeable standby state when the main control unit 116 determines that the vehicle on the corresponding parking space is an electric vehicle. For example, the main control unit 116 controls the state indication unit 115 to show green light to inform the vehicle owner that he can take the charging connector 120 to execute charging. In one embodiment, the lock mechanism lifts the lock state of the charging connector 120 when the main control unit 116 finishes lifting the hibernate state of the charging station. In one embodiment, the main control unit 116 can control the state indication unit 115 to show a being-charged state during the charging process. For example, the main control unit 116 controls the state indication unit 115 to show slow flashing green light to inform the vehicle owner of being charging. In addition, in another embodiment, the image capturing unit 113 keeps capturing the image during the charging process of the vehicle and the main control unit 116 keeps executing the image recognition, to ensure that the charging connector 120 executes charging for the vehicle on the corresponding parking space and is always positioned on the charging stand of the corresponding parking space during the charging process, to avoid malversation. Once the main control unit 116 finds that the charging connector 120 does not execute charging for the vehicle on the corresponding parking space or is moved to the other vehicles, the main control unit 116 stops the charging process of the charging station 100. Meanwhile, the main control unit 116 informs the vehicle owner through the application program and the vehicle owner can also stop the charging process by using the application program if the vehicle owner is a registered member. The vehicle owner is informed via text message if he is not a registered member.

In one embodiment, the main control unit 116 of the present disclosure determines that the charging process ends and stops charging, after the vehicle owner moves the charging connector 120 from the charging stand of the vehicle during the charging process when the in-time power of the charging connector measured by the electricity meter 118 has maintained zero for a period, such as ten minutes. Then, the main control unit 116 sends a charging end signal to the backend management server 200 on the remote end through the communication unit 117 and the processing unit 201 executes the subsequent checkout process. In one embodiment, the processing unit 201 collects a fee for the vehicle owner according to the license plate number and the vehicle type stored in the storage unit 202. Alternatively stated, only when both the license number and the vehicle type match the charged vehicle, collecting a fee starts up. In one embodiment, the processing unit 201 checks the license plate number and the vehicle type stored in the registration information for the vehicle owner if the vehicle owner is a registered member and the payment method is bound. Automatic bill payment is executed and the user is informed of the payment result if the license number and the vehicle type match the charged vehicle. The main control unit 116 can display the charging fee on the display unit 112 together with the license plate number and the vehicle number for the vehicle owner to make confirmation and payment if the vehicle owner is not a registered member. In one embodiment, the fee collection method can be divided into two according to parking time and charging time. Alternatively stated, the parking fee is collected according to the parking time and the charging fee is collected according to the charging time for convenience in collecting the parking fee and the charging fee. In one embodiment, the charging fee can be collected according to the charged kilowatt hour.

In one embodiment, the display unit 112 can be a touch display unit for the vehicle owner to input the required charging parameters. The main control unit 116 can control the charging connector 120 to execute charging according to the inputted charging parameters. In one embodiment, the vehicle owner inputs the charging parameters, such as the money amount for charging or the reserved charging time. The main control unit 116 stops the charging process after the set charging parameters is reached in charging. In the charging process, the main control unit 116 can further capture the in-time power measured by the electricity meter 118 inside the station body 110 to execute calculation to display state information, such as an in-time charging voltage, an in-time charging current, the in-time power for charging, and the charging fee on the display unit 112.

In one embodiment, the processing unit 201 of the backend management server 200 can execute an image recognition process to perform image processing, character splitting, character recognition for the exterior image of the vehicle to recognize vehicle information about the vehicle, such as the license plate number and the vehicle type, and stores the recognition results and the exterior image of the vehicle in the storage unit 202 when the main control unit 116 in the charging station 100 cannot execute the image recognition or does not recognize the captured image. Meanwhile, the backend management server 200, through the communication network 300, returns the results determined according to the license plate number and the vehicle type, such as whether the vehicle on the corresponding parking space is an electric vehicle and whether the vehicle owner is a registered member, to the main control unit 116. Accordingly, the main control unit 116 execute corresponding processing mentioned above, such as keeping the state of the charging station 100 in the hibernate state and or switching the state of the charging station 100 to the standby state, and controlling the voice warning unit 114 to generate a warning message, and the control method thereof was described as above and will not be repeated here. In one embodiment, the processing unit 201 can be implemented by a CPU, a MPU, a MCU, a DSP, and a ASIC. The storage unit 202 can be any type of fixed or moveable random access memory (RAM), Read-Only Memory (ROM), flash memory, Hard Disk Drive (HDD), Solid State Drive (SSD) or similar elements, or any combination thereof.

In one embodiment, the charging process is very long and thereby the vehicle owner often executes charging at night. In the charging process, the charging connector 120 is protruded outside the vehicle body. Particularly, for charging on the parking space on the road side, the protruded charging connector 120 will cause danger to passersby. Therefore, a warning device 122 is further arranged on the charging connector 120 of the present disclosure. In one embodiment, the warning device 122 is a light-emitting element and can flash or glow to remind and warn the passersby.

In one embodiment, because the direction of parking on the road side must go along the direction of driving, the position of the charging stand of the electric vehicle is not necessarily designed on the side surface close to the station body 110 and likely arranged on the side surface close to the road. Therefore, the station body 110 of the present disclosure further includes an extended charging tube 123, such as a soft tube or a L-shaped tube, configured to couple with the charging connector 120 to extend a charging range so as to provide the vehicle owner with more convenient service. The charging connector 120 needs not be inserted on the position of the charging stand by coupling with the soft tube or the L-shaped tube so as to maintain the charging connector 120 on the position of not occupying the road, avoiding causing danger to the passersby.

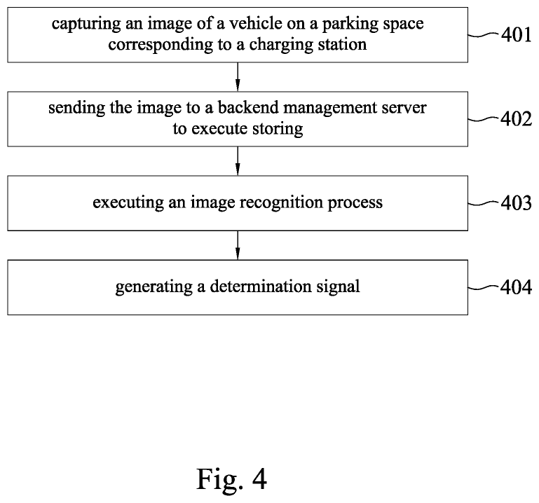

FIG. 4 is a flow diagram of a method for charging an electric vehicle in accordance with to one embodiment of the present disclosure. Reference is now made to FIG. 1 to FIG. 4. First, in Step 401, an image of a vehicle on a parking space corresponding to a charging station is captured. In one embodiment, an image of a vehicle on a parking space corresponding to a charging station 100 is captured by using an image capturing unit 113 provided on the charging station 100. In Step 402, the image is send to a backend management server 200 to execute storing. In one embodiment, the charging station 100 communicates with the backend management server 200 through a communication network 300. Therefore, the charging station 100 can send the image captured by the image capturing unit 113 to the backend management server 200 to execute storing. In Step 403, an image recognition process is executed. In one embodiment, the main control unit 116 on the charging station 100 executes an image recognition process for the image so as to capture a license plate number and a vehicle type from the image. In Step 404, a determination signal is generated. In one embodiment, the main control unit 116 on the charging station 100 generates the determination according to the recognized license number and vehicle type to determine if the charging station 100 is switched from a hibernate state to a standby state to execute charging for the vehicle.

In view of the above, the present disclosure recognizes the license plate number and the vehicle through arranging an image capturing device, configured to capture the image of the charging vehicle. In addition to automatically determining if the charging process is switched on and the fee is subsequently collected, the present disclosure further executes monitoring in the charging process and thereby avoids that the charged vehicle is not the recognized vehicle and the charging connector is maliciously moved into other vehicles to execute charging.

Although the present disclosure has been described in considerable detail with reference to certain embodiments thereof, the description of the embodiments does not limit the present disclosure. Anyone skilled in the art can make various modifications and variations without departing from the scope or spirit of the disclosure. Therefore, it is intended that the present disclosure depends on the appended claims in the following.

What is claimed is:

1. An electric vehicle charging system, comprising:
a plurality of charging stations arranged on a plurality of parking spaces respectively, wherein each of the plurality of charging stations further comprises an image capturing unit, a main control unit and a charging connector provided for a vehicle on a corresponding parking space to execute charging; and
a backend management server connected with the plurality of charging stations through a communication network,
wherein the image capturing unit on each of the plurality of charging stations is configured to capture an image of the vehicle on the corresponding parking space,
wherein the main control unit is configured to execute an image recognition process for the image to capture a license plate number and a vehicle type of the vehicle from the image to generate a determination signal according to the license plate number and the vehicle type to determine if a corresponding charging station is switched from a hibernate state to a standby state to execute charging for the vehicle, and to collect a charging fee according to the license plate number and the vehicle type after charging is complete,
wherein the main control unit sends the license plate number, the vehicle type and the image to the backend management server to execute storing through the communication network.

2. The electric vehicle charging system of claim 1, wherein the charging connector further comprises:
a warning device thereon configured to send out a warning signal when the charging connector is provided for the vehicle on the corresponding parking space to execute charging.

3. The electric vehicle charging system of claim 1, wherein each of the plurality of charging stations further comprises:
an extended charging tube configured to couple with the charging connector to extend a charging range of the charging connector.

4. The electric vehicle charging system of claim 1, wherein the image recognition process is executed by the backend management server for the image when the main control unit cannot execute the image recognition process for the image.

5. The electric vehicle charging system of claim 1, wherein each of the plurality of charging stations further comprises a voice warning unit coupled with the main control unit, and the main control unit further controls the voice warning unit to generate a warning message when the main control unit keeps the corresponding charging station in the hibernate state according to the determination signal.

6. The electric vehicle charging system of claim 1, wherein each of the plurality of charging stations further comprises a state indication unit coupled with the main control unit, and the main control unit switches the state indication unit to indicate whether the corresponding charging station is in the hibernate state or the standby state.

7. The electric vehicle charging system of claim 1, wherein the image capturing unit keeps capturing a continuous image of the vehicle and the main control unit determines if an object which is charged by the charging connector is the vehicle according to the continuous image after the corresponding charging station switches from the hibernate state to the standby state.

8. The electric vehicle charging system of claim 7, wherein the main control unit stops charging the charging connector when the main control unit determines that the charging connector does not charge the vehicle according to the continuous image.

9. The electric vehicle charging system of claim 1, wherein the charging connector is locked in a charging-connector socket when in the hibernate state, and the charging connector is unlocked in the standby state.

10. The electric vehicle charging system of claim 1, wherein the charging connector is locked in a charging-connector socket in the hibernate state.

11. The electric vehicle charging system of claim 1, wherein the charging connector is unlocked in the standby state.

12. The electric vehicle charging system of claim 1, wherein the image capturing unit keeps capturing a continuous image of the vehicle and the main control unit determines if an object which is charged by the charging connector is the vehicle according to the continuous image after the corresponding charging station switches from the hibernate state to the standby state,
wherein the main control unit stops charging the charging connector when the main control unit determines that the charging connector does not charge the vehicle according to the continuous image.

13. The electric vehicle charging system of claim 1, wherein the backend management server provides an application program to be downloaded to execute registration.

14. A method for operating an electric vehicle charging system, comprising the steps of:
capturing an image of a vehicle on a parking space corresponding to a charging station by using an image capturing unit provided on the charging station;
sending the image to a backend management server, wherein the charging station sends the image to the backend management server through a communication network;
executing an image recognition process by using a main control unit provided inside the charging station to capture a license plate number and a vehicle type; and
generating a determination signal, wherein the main control unit generates the determination signal according to the license plate number and the vehicle type to decide whether to switch the charging station from a hibernate state to a standby state to execute charging for the vehicle.

15. The method of claim 14, further comprising the step of:
collecting a fee according to the license plate number and the vehicle type.
